(19) United States
(12) Patent Application Publication
(10) Pub. No.: US 2013/0042930 A1
(43) Pub. Date: Feb. 21, 2013

(54) Hydraulic Pilot Control Unit

(71) Applicants: Wolfgang Kauss, Francheville (FR); Gerard Laroze, Mions (FR)

(72) Inventors: Wolfgang Kauss, Francheville (FR); Gerard Laroze, Mions (FR)

(73) Assignee: Robert Bosch GmbH, Stuttgart (DE)

(21) Appl. No.: 13/575,280

(22) PCT Filed: Dec. 22, 2010
(86) PCT No.: PCT/EP2010/007886

§ 371 Date: Oct. 8, 2012

(30) Foreign Application Priority Data
Jan. 29, 2010 (DE) 10 2010 006 196.4

(51) Int. Cl. F16K 31/36

(52) U.S. Cl. 137/494

(57) ABSTRACT

A hydraulic pilot control unit includes at least one pressure control valve that can be controlled by means of an actuating device. The pressure control valve includes a control piston connected to a stem by means of a neck. The stem has a resilient operative connection to the actuating device. The neck is fastened to the stem. Thus, the mass of the control piston, which tends to oscillate, is reduced compared to the prior art.

The invention relates to a hydraulic pilot control unit according to the preamble of patent claim 1.

Such hydraulic pilot control units having pressure-regulating valves serve, in particular, for pressurizing and therefore adjusting valve spools of valves or main stages, which are subjected to relatively high pressure forces. For this purpose the pilot control units comprise joysticks or handles, which serve for adjusting the respective control pistons of the pressure-regulating valves.

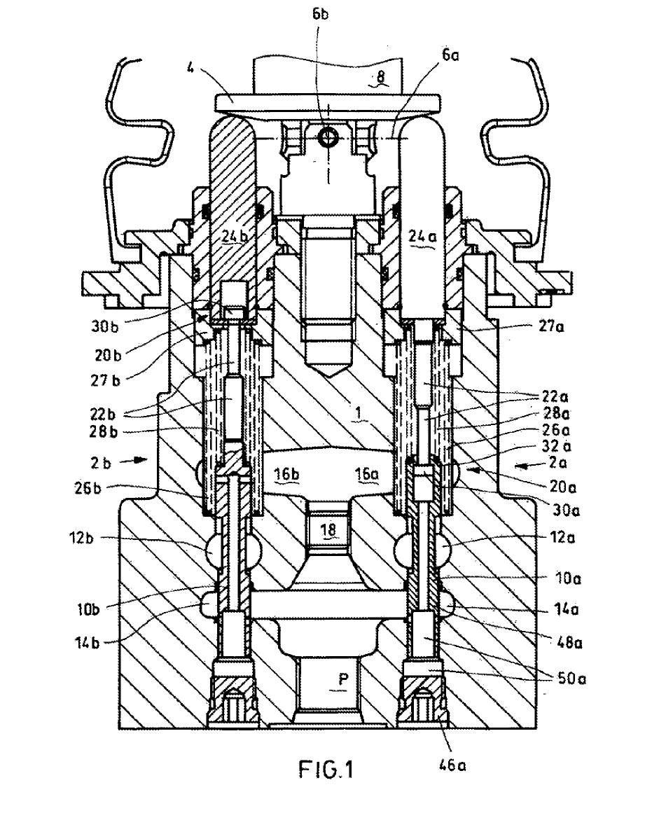

DE 196 22 948 A1 shows a pressure-regulating valve of such a hydraulic pilot control unit. Here (according to FIG. 1) a control pressure present acting on the connection P is transmitted wholly or partially to a working connection A, when a control piston is displaced in an opening direction by a tappet.

One disadvantage to such hydraulic pilot control units is that oscillations can be induced in the control piston here by pressure acting on various surfaces and by various springs. This is exacerbated by the fact that the control piston is composed of iron and thereby has a relatively large mass. Furthermore, the inducement of oscillations is exacerbated in that the control piston has a relatively long neck, via which a main portion of the control piston is connected to the tappet.

DE 103 24 051 A1 shows a pressure-reducing valve, the control piston of which, embodied as a stepped piston, is relatively heavily damped. For this purpose a damping passage is provided with a damping pin. This increases the stability of the feedback loop, but at the same time also presents disadvantages, such as a slower response speed, for example.

A further possible way of increasing the stability is to reduce the gain of the feedback loop in accordance with FR 2 857 705 B1.

In the light of this, the object of the invention is to create a hydraulic pilot control unit having at least one pressure-regulating valve, in which the stability of the feedback loop is increased through a directly acting parameter.

This object is achieved by a hydraulic pilot control unit having the features of patent claim 1.

The hydraulic pilot control unit according to the invention has at least one pressure-regulating valve, which can be controlled by way of an actuating device and which comprises a control piston connected to a tappet by way of a neck. Here the tappet is operatively connected to the actuating device. According to the invention the neck is fixed to the tappet. This serves to reduce the mass of the control piston susceptible to oscillations, as compared to the state of the art. A directly acting parameter of the feedback loop of the pressure regulating valve is therefore modified in such a way that the inducement of oscillations in the control piston is reduced. This also serves, for example, to reduce the noise generated by the hydraulic pilot control unit according to the invention.

Further advantageous developments of the invention are described in the dependent patent claims.

In an especially preferred development each control piston is composed substantially of aluminum or plastic. This further reduces its mass and hence the inducement of oscillations, compared to steel.

In an especially preferred development each tappet and the associated control piston can be displaced by the actuating device in an opening direction of the control piston. In this case a shear-elastic connection is provided between each neck and the associated control piston.

The shear-elastic connection is preferably formed by a regulating spring and by a head, fixed to an end portion of the neck and inserted into a recess arranged on a first end portion of the control piston. The regulating spring here is supported against the tappet and biases the control piston in an opening direction. The head is received in the recess in opposition to the force of the regulating spring, so that it is displaceable in an opening direction. This allows for the possibility of a jump in pressure on a working connection of the associated pressure-regulating valve during a first part of an adjustment travel of the operating unit or the tappet.

It is especially preferred if each head can be brought into bearing contact with an end face of the recess when the associated tappet is displaced in an opening direction. Beyond a predefined differential between a regulating spring force and pressure forces acting in opposition, this affords a direct or unsprung displacement of the control piston in an opening direction, resulting in a jump in pressure on the working connection.

In an especially preferred development each pressure-regulating valve has a return spring, which is supported against a housing of the pilot control unit or of the associated pressure-regulating valve, and which biases the tappet in a closing direction. A force acting in a closing direction of the pressure-regulating valve is thereby generated in opposition to a manual force acting on the operating control element, in order to close the pressure-regulating valve again after an actuation.

It is preferred if each recess is defined in a closing direction by a return bearing surface, with which the associated head can be brought into bearing contact.

The return spring, by way of the tappet, the neck, the head and the return bearing surface, can thereby draw the control piston in the closing direction.

To facilitate assembly and the connection of the tappet to the control piston, each first end portion of the control piston may comprise a lateral passage, through which the head can be inserted into the recess.

In a preferred development the control piston is a stepped piston, which has a first ring surface acting in an opening direction and a second ring surface acting in a closing direction, both of which surfaces are subjected to the pressure of a working connection of the pressure-regulating valve. Here the first ring surface is smaller than the second ring surface. A pressure force acting on the control piston in a closing direction is thereby generated.

In a practically relevant exemplary embodiment of the pilot control unit according to the invention four pressure-regulating valves are provided, two pressure-regulating valves in each case being connected by way of their associated working connections to a valve spool of a consumer or a main stage.

It is preferred if each pressure-regulating valve has a control pressure chamber and a tank pressure chamber and a working pressure chamber arranged between them, multiple control pressure chambers being connected to a common control pressure connection of the pilot control unit and multiple tank pressure chambers being connected to a common tank connection of the pilot control unit.

For pressure balancing it is preferred if each control piston comprises a longitudinal bore, a chamber arranged between the housing and a second end portion of the control piston remote from the respective tappet being connected to the tank pressure chamber by way of the longitudinal bore and by way of the passage.

In a practically relevant exemplary embodiment the actuating device has a joystick. If the hydraulic pilot control unit according to the invention is arranged in an excavator, excavator-loader, telescoping loader, wheeled loader, compact loader or crane, the noise reduction achieved through the reduction in oscillations is particularly advantageous for a driver or operator.

An exemplary embodiment of the invention is described in detail below with reference to the figures, of which:

FIG. 1 shows a substantial detail of an exemplary embodiment of a hydraulic pilot control unit according to the invention in lateral section, a pressure-regulating valve according to the state of the art and a pressure-regulating valve according to the invention being shown combined;

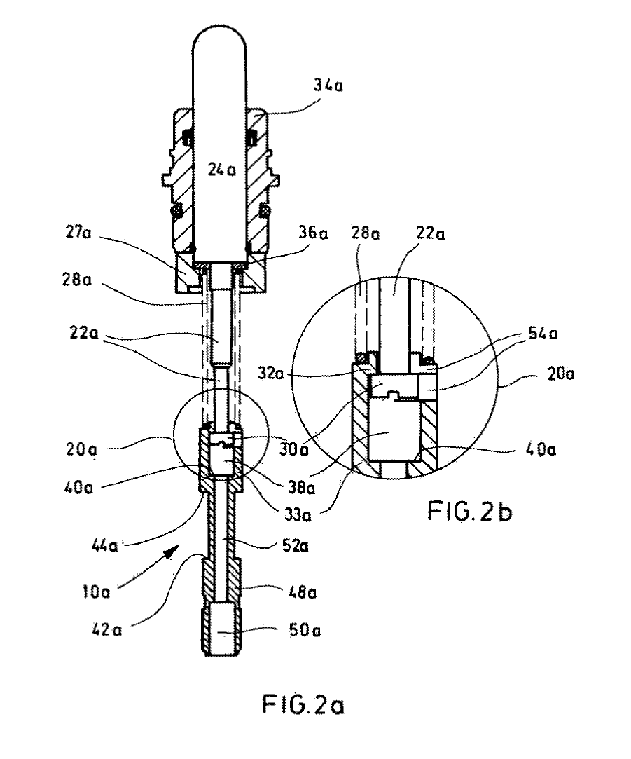

FIG. 2a shows an enlarged detail of the exemplary embodiment according to the invention in FIG. 1 in a further lateral section; and

FIG. 2b shows a detail enlargement of the shear-elastic connection in FIG. 2a.

FIG. 1 shows a substantial detail of an exemplary embodiment of a hydraulic pilot control unit according to the invention in lateral section. Four pilot control valves embodied as pressure-regulating valves, of which only two pressure-regulating valves 2a, 2b are represented in FIG. 1, are arranged in a housing 1. The pressure-regulating valves 2a, 2b are actuated by a rocking actuation plate 4, which can be inclined about a horizontally running first rocker axis 6a (FIG. 1), and in relation to the housing 1 by way of a second rocker axis 6b, arranged perpendicularly to the drawing plane. This is done by way of a joystick fixed to the actuation plate 4 above the latter, only a relatively small part 8 of which joystick is shown in FIG. 1. Fitted to this part 8 is a handle, which serves for inclining the actuation plate 4 about the two rocker axes 6.

The two pressure-regulating valves 2a, 2b are shown in their respective neutral positions, in which a respective control piston 10a, 10b is arranged in an upper closed position in the housing 1, so that a respective working pressure chamber 12a, 12b and thereby a working connection (not shown) associated with each of these is not supplied with control pressure. For this purpose a hydraulic fluid connection, running from the central control pressure connection P of the pilot control unit according to the invention via the control pressure chambers 14a, 14b assigned to the respective pressure-regulating valves 2a, 2b, to the respective working pressure chambers 12a, 12b, is shut off by the control piston 10a, 10b.

In the neutral position shown the working pressure chamber 12a, 12b is connected by control grooves (not shown) of the control piston 10a, 10b to a respective tank pressure chamber 16a, 16b and is therefore relieved of pressure. The tank pressure chambers 16a, 16b are connected to a tank (not shown) by way of a common tank connection (not shown) of the pilot control unit. The tank pressure chambers 16a, 16b are furthermore isolated from the control pressure chambers 14a, 14b and thereby from the control pressure connection P by a screw plug or a plug 18.

Each control piston 10a, 10b is connected by a shear-elastic connection 20a, 20b and by a neck 22a, 22b to a tappet 24a, 24b. The tappet 24a, 24b is biased upwards into the neutral position by a return spring 26a, 26b and a ring 27a, 27b (in FIG. 1). For this purpose the return spring 26a, 26b is supported against a radial flange of the housing 1. The control piston 10a, 10b is thereby also drawn into its neutral position against a (in FIG. 1) downwardly directed force of a regulating spring 28a, 28b.

In the case of the pressure-regulating valve 2b according to the invention represented on the right in FIG. 1 the piston is drawn into the neutral position by the neck 22a, which is fixed to the tappet 24a and attached to the end portion of which, facing the control piston 10a, is a head 30a formed by a radial extension. The head 30a grips behind a return bearing surface 32a of an adjacent first end portion 33a of the control piston 10a.

FIG. 2a shows an enlarged detail of the pressure-regulating valve 2a according to the invention in a further lateral section, which is set at 90 degrees to the section in FIG. 1. Here the tappet 24a with the neck 22a and with the head 30a is again shown in its neutral position. A sleeve-shaped tappet guide 34a, fixed to the housing, is provided for guiding a (in FIG. 2a) downwardly directed movement of the tappet 24a.

Also shown is the ring 27a, by way of which the tappet 24a is biased (in FIG. 2a) upwards in the closing direction by the return spring 26a (not shown in FIG. 2a).

Arranged concentrically inside the ring 27a is a washer 36a, on which the regulating spring 28a is supported against the tappet 24a and in so doing biases the control piston 10a in an opening direction. An end-face concentric recess 38a, the diameter of which is approximately equal to that of the head 30a, is inserted on the first end portion 33a of the control piston 10a. The recess 38a radially is more tightly stepped at an end face of the first end portion 33a, so that a return bearing surface 32a is formed. In the neutral position shown the head 30a bears against the return bearing surface 32a.

On its side situated opposite the return bearing surface 32a the recess 38a has an end face 40a, a predefined interval being provided between the head 30a and the end face 40a. This interval serves to define a length of travel of the tappet 24a in an opening direction of the pressure-regulating valve 2a, over which—apart from pressure forces—only a force of the regulating spring 28 is operative. In the event of a further opening movement of the tappet 24a, the head 30a comes into bearing contact with the end face 40a and then assists the (in the figures) downwardly directed opening movement of the control piston 10a. A jump in pressure at the respective working pressure chamber 12a and at the associated working pressure connection is thereby possible at the end of the control range of the hydraulic pilot control unit according to the invention.

As the joystick (not shown) pivots back about the second rocker axis 6b (cf. FIG. 1) from an assumed inclination to the right, for the reasons described above the tappet 24a moves (in the figures) upwards, the head 30a coming into bearing contact with the return bearing surface 32a and in so doing carrying the control piston 10a with it over the return bearing surface 32a.

The control piston 10a is a stepped piston having two ring surfaces 42a, 44a (cf. FIG. 2) subjected to the pressure of the working pressure chamber 12a, the second ring surface 44a acting in the closing direction of the control piston 10a being larger than the first ring surface 42a acting in the opening direction.

The first control edge assigned to the first ring surface 42a controls the hydraulic fluid connection from the control pressure chamber 14a to the working pressure chamber 12a, whilst the second control edge assigned to the second ring surface 44a controls the hydraulic fluid connection from the working pressure chamber 12a to the tank pressure chamber 16a. Here a (comparatively small) cross section between the working pressure chamber 12a and the tank pressure chamber 16a is opened also in the neutral position.

FIG. 1 shows a sealing plug 46a, which is screwed in the housing 1 and which together with a second end portion 48a of the control piston 10a defines a chamber 50a.

FIG. 2a shows that the chamber 50a is connected by way of a longitudinal bore 52a to the recess 38a.

FIG. 2b shows a detail enlargement of the shear-elastic connection 20a in a sectional view according to FIG. 2a. Here a radial passage 54a is provided laterally on the first end portion 33a of the control piston 10a. The chamber 50a is thereby connected to the tank pressure chamber 16a by way of the longitudinal bore 52a, the recess 38a and the lateral passage 54a (cf. FIG. 1) and is therefore relieved.

FIG. 2a shows the passage 54a, which is formed partly in the return bearing surface 32a and partly in the area of the recess 38a. When assembling or putting the tappet 24a together with the control piston 10a, the passage 54a allows the head 30a to be pushed radially into the recess 38a.

FIG. 1 provides an illustration through a comparison of the exemplary embodiment of the pressure-regulating valve 2a represented on the right (in the figure) with an example of a pressure-regulating valve 2b according to the state of the art represented on the left (in the figure). The neck 22b and the head 30b, which according to the state of the art are fixed to the control piston 10b, are according to the invention separated therefrom and are associated with the tappet 24a. The volume and hence the mass of the tappet 10a according to the invention are thereby significantly reduced compared to the tappet 10b. Tests have confirmed that this reduction in the mass leads to a distinctly reduced inducement of oscillations of the control piston 10a and thereby of the hydraulic pilot control unit according to the invention.

It has further emerged from tests that a hydraulic pilot control unit, in which the necks of its pressure-regulating valves are not fixed to the tappet in accordance with the invention, but the necks of which are fixed to the respective control piston as in the state of the art, likewise exhibits a good oscillation damping if the control pistons are produced from a lighter material. Such materials include, in particular, aluminum and plastic.

The invention discloses a hydraulic pilot control unit, which comprises at least one pressure-regulating valve, which can be controlled by way of an actuating device and which in turn comprises a control piston connected to a tappet by way of a neck. Here the tappet has a resilient operative connection to the actuating device. According to the invention the neck is fixed to the tappet. This serves to reduce the mass of the control piston susceptible to oscillations, in comparison with the state of the art.

1. A hydraulic pilot control unit comprising:
at least one pressure-regulating valve, which can be controlled by way of an actuating device and which comprises a control piston, which is connected to a tappet by way of a neck,
wherein the tappet is operatively connected to the actuating device, and
wherein the neck is fixed to the tappet.

2. The hydraulic pilot control unit as claimed in claim 1, wherein each control piston is composed substantially of aluminum or plastic.

3. The hydraulic pilot control unit as claimed in claim 1, wherein:
each tappet and the associated control piston can be displaced by the actuating device in an opening direction of the control piston, and
a shear-elastic connection is provided between each neck and the associated control piston.

4. The hydraulic pilot control unit as claimed in claim 3, wherein:
each shear-elastic connection has a regulating spring, which is supported against the tappet and which biases the control piston in an opening direction, and
a head, which is fixed to an end portion of the neck and is inserted into a recess formed on a first end portion of the control piston, and is displaceable therein in an opening direction.

5. The hydraulic pilot control unit as claimed in claim 4, wherein each head can be brought into bearing contact with an end face of the recess when the associated tappet is displaced in an opening direction.

6. The hydraulic pilot control unit as claimed in claim 1, wherein each pressure-regulating valve has a return spring, which is supported against a housing of the associated pressure-regulating valve or of the pilot control unit, and which biases the tappet in a closing direction.

7. The hydraulic pilot control unit as claimed in claim 4, wherein each recess is defined in a closing direction by a return bearing surface, with which the associated head can be brought into bearing contact.

8. The hydraulic pilot control unit as claimed in claim 4, wherein each first end portion of the control piston comprises a lateral passage, through which the head can be inserted into the recess.

9. The hydraulic pilot control unit as claimed in claim 6, wherein:
the control piston is a stepped piston, which has a first ring surface acting in an opening direction and a second ring surface acting in a closing direction, both of which surfaces are subjected to the pressure of a working connection of the associated pressure-regulating valve, and
the first ring surface is smaller than the second ring surface.

10. The hydraulic pilot control unit as claimed in claim 9, wherein:
four pressure-regulating valves are provided, and
two pressure-regulating valves are in each case connected by way of their associated working connections to a valve spool of a consumer.

11. The hydraulic pilot control unit as claimed in claim 1, wherein:
each pressure-regulating valve has a control pressure chamber and a tank pressure chamber and a working pressure chamber arranged between them, and
multiple control pressure chambers are connected to a control pressure connection of the pilot control unit and multiple tank pressure chambers are connected to a tank connection of the pilot control unit.

12. The hydraulic pilot control unit as claimed in claim 6, wherein:
each control piston comprises a longitudinal bore, and
a chamber arranged between the housing and a second end portion of the control piston remote from the respective tappet is connected to the tank pressure chamber by way of the longitudinal bore and by way of the passage.

13. The hydraulic pilot control unit as claimed in claim 1, wherein the actuating device has a joystick of an excavator, excavator-loader, telescoping loader, wheeled loader, compact loader or crane.
